(19) United States
(12) Patent Application Publication
(10) Pub. No.: US 2012/0110575 A1
(43) Pub. Date: May 3, 2012

(54) SECURE PARTITIONING WITH SHARED INPUT/OUTPUT

(75) Inventors: William L. Weber, III, Eagleville, PA (US); David A. Kershner, Marcus Hook, PA (US); John A. Landis, Pipersville, PA (US); William P. Jordan, Lancaster, PA (US)

(73) Assignee: Unisys Corp., Blue Bell, PA (US)

(21) Appl. No.: 12/955,127

(22) Filed: Nov. 29, 2010

Related U.S. Application Data
(60) Provisional application No. 61/408,018, filed on Oct. 29, 2010.

(51) Int. Cl. G06F 9/455

(52) U.S. Cl. 718/1

(57) ABSTRACT

A soft partitioning system for allowing multiple virtual system environments to execute on a single platform may include I/O service partitions (IOSPs). The IOSPs operating in a separate virtual memory space on the platform and service disk and network requests from multiple guests. The IOSPs provide translation from virtual addresses to physical addresses such that from the point of view of the guest the virtual addresses used by the guest appear to be physical addresses. The IOSP may be implemented in a Linux kernel. The address space of the IOSP may be extended to include DMA memory sections such that the Linux kernel does not include all of the guest's memory. The IOSP may operate on hardware that does or does not support virtualization technology for directed I/O.

### CROSS REFERENCE TO RELATED APPLICATIONS

This application is related to U.S. Provisional Application Ser. No. 61/408,018, entitled Secure Partitioning with Shared Input/Output, filed Oct. 29, 2010, the disclosure of which is hereby incorporated herein by reference.

### TECHNICAL FIELD

The instant disclosure relates to virtual system environments. More specifically, the disclosure relates to sharing input/output devices in a virtual system environment.

### BACKGROUND

In conventional virtual system environments, multiple guests share a physical device mapped by input/output addresses. Input/output (I/O) accesses are performed by a device in an I/O service partition and copied to memory of a guest platform. As a result at least two copies of data may occupy memory. Additionally, one guest may be able to see another guest's data. Thus, conventional virtual system environments consume excessive resources and lack strong security features.

### SUMMARY

According to one embodiment, an apparatus includes a guest partition. The apparatus also includes an input/output service partition (“IOSP”) coupled to the guest partition through a control channel. The apparatus further includes a memory management unit (“MMU”) coupled to the IOSP. The apparatus also includes a platform memory coupled to the MMU.

According to another embodiment, a method includes receiving an input/output (I/O) request from a guest at an IOSP. The method also includes translating a guest physical address of the I/O request to an IOSP relative physical address. The method further includes accessing the physical device corresponding to the IOSP relative physical address. The method also includes accessing shared memory of the guest by the physical device.

According to yet another embodiment, a method includes assigning a first plurality of bits of a memory address to store an address. The method also includes assigning a second plurality of bits of a memory address to store information.

According to a further embodiment, a method includes receiving a memory address for an input/output (“I/O”) request. The method also includes translating the memory address to an IOSP address. The method further includes setting a translator bit of the memory address indicating the memory address has been translated. The method also includes passing the memory address to an operating system.

According to another embodiment, a computer program product includes a computer readable medium having code to assign a first plurality of bits of a memory address to store an address. The medium also includes code to assign a second plurality of bits of a memory address to store information.

According to yet another embodiment, a computer program product includes a computer readable medium having code to receive a memory address for an I/O request. The medium also includes code to translate the memory address to an IOSP address. The medium further includes code to set a translator bit of the memory address indicating the memory address has been translated. The medium also includes code to pass the memory address to an operating system.

According to a further embodiment, a computer program product includes a computer-readable medium having code to receive an I/O request from a guest. The medium also includes code to translate a guest physical address of the I/O request to an IOSP relative physical address. The medium further includes code to access the physical device corresponding to the IOSP relative physical address. The medium also includes code to access shared memory of the guest.

The foregoing has outlined rather broadly the features and technical advantages of the disclosed system environments in order that the detailed description of the system environments that follows may be better understood. Additional features and advantages of the system environments will be described hereinafter which form the subject of the claims of the instant application. It should be appreciated by those skilled in the art that the conception and specific embodiment disclosed may be readily utilized as a basis for modifying or designing other structures for carrying out the same purposes of the system environments. It should also be realized by those skilled in the art that such equivalent constructions do not depart from the spirit and scope of the invention as set forth in the appended claims. The novel features which are believed to be characteristic of the system environments, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the claimed invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating a system for providing a virtual system environment according to one embodiment of the disclosure.

FIG. 2 is a block diagram illustrating a computer system for providing a virtual system environment according to one embodiment of the disclosure.

FIG. 3 is a block diagram illustrating a virtual system environment according to one embodiment of the disclosure.

FIG. 4 is a flow chart illustrating the use of a memory address to convey information in non VT-d system according to one embodiment of the disclosure.

FIG. 5 is a flow chart illustrating a method according to one embodiment of the disclosure.

FIG. 6 is a flow chart illustrating a method according to another embodiment of the disclosure.

FIG. 7 is a flow chart illustrating a method according to yet another embodiment of the disclosure.

### DETAILED DESCRIPTION

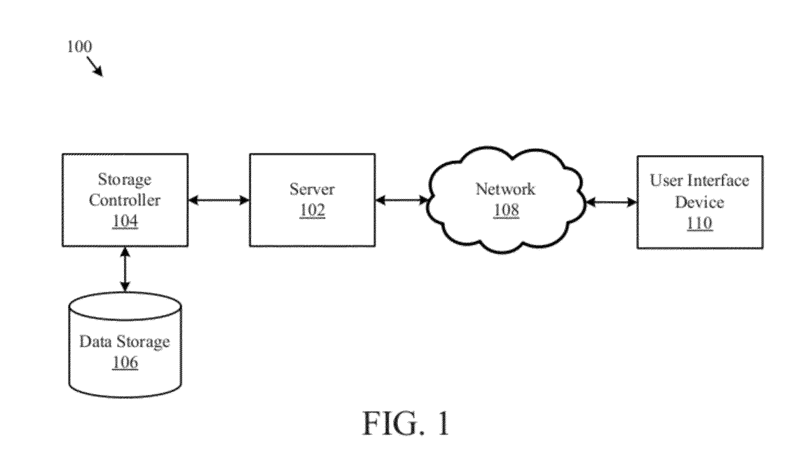

FIG. 1 illustrates an embodiment of a system 100 for running virtual systems. The system 100 may include a server 102, a data storage device 106, a network 108, and a user interface device 110. The server 102 may or may not support virtualization technology for directed I/O (“VT-d”). In a further embodiment, the system 100 may include a storage controller 104, or storage server configured to manage data communications between the data storage device 106, and the server 102 or other components in communication with the network 108. In an alternative embodiment, the storage controller 104 may be coupled to the network 108.

In some embodiments, the user interface device 110 is referred to broadly and is intended to encompass a suitable processor-based device such as, without limitation, a desktop computer; a laptop computer; a personal digital assistant (“PDA”), a tablet computer, a smartphone, or other fixed or mobile communication device or organizer device having access to the network 108. In a further embodiment, the user interface device 110 may access the Internet or other wide area or local area network to access a web application or web service hosted by the server 102 and provide a user interface for enabling a user to enter or receive information.

The network 108 may facilitate communications of data between the server 102 and the user interface device 110. The network 108 may include any type of communications network including, but not limited to, a direct PC-to-PC connection, a local area network (LAN), a wide area network (“WAN”), a modem-to-modem connection, the Internet, a combination of the above, or any other communications network now known or later developed within the networking arts which permits two or more computers or other user interface devices to communicate, one with another.

The server may access data stored in the data storage device 106 via a Storage Area Network (“SAN”) connection, a LAN, a data bus, or the like. The data storage device 106 may include a hard disk, including hard disks arranged in an Redundant Array of Independent Disks (“RAID”) array; a tape storage drive comprising a magnetic tape data storage device; an optical storage device, or the like. The data may be arranged in a database and accessible through Structured Query Language (“SQL”) queries, or other database query languages or operations.

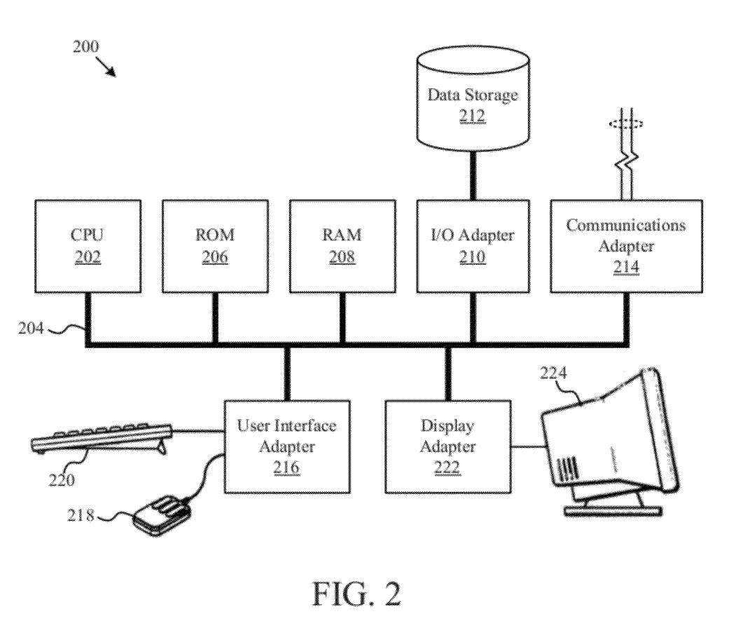

FIG. 2 illustrates a computer system 200 adapted according to certain embodiments of the server 102 and/or the user interface device 110. The central processing unit (“CPU”) 202 is coupled to the system bus 204. The CPU 202 may be a general purpose CPU or microprocessor, graphics processing unit (“GPU”), microcontroller, or the like. The present embodiments are not restricted by the architecture of the CPU 202 so long as the CPU 202, whether directly or indirectly, supports the modules and operations as described herein. The CPU 202 may execute the various logical instructions according to the present embodiments.

The computer system 200 also may include random access memory (“RAM”) 208, which may be SRAM, DRAM, SDRAM, or the like. The computer system 200 may utilize RAM 208 to store the various data structures used by a software application for running virtual system environments. The computer system 200 may also include read only memory (“ROM”) 206 which may be PROM, EPROM, EEPROM, optical storage, or the like. The ROM may store configuration information for booting the computer system 200. The RAM 208 and the ROM 206 hold user and system data. The computer system 200 may also include an input/output (I/O) adapter 210, a communications adapter 214, a user interface adapter 216, and a display adapter 222.

The I/O adapter 210 may connect one or more storage devices 212, such as one or more of a hard drive, a compact disk (CD) drive, a floppy disk drive, and a tape drive, to the computer system 200. The communications adapter 214 may be adapted to couple the computer system 200 to the network 108, which may be one or more of a LAN, WAN, and/or the Internet. The user interface adapter 216 couples user input devices, such as a keyboard 220 and a pointing device 218, to the computer system 200. The display adapter 222 may be driven by the CPU 202 to control the display on the display device 224.

The applications of the present disclosure are not limited to the architecture of computer system 200. Rather the computer system 200 is provided as an example of one type of computing device that may be adapted to perform the functions of a server 102 and/or the user interface device 110. For example, any suitable processor-based device may be utilized including without limitation, including personal data assistants (“PDAs”), tablet computers, smartphones, computer game consoles, and multi-processor servers. Moreover, the systems and methods of the present disclosure may be implemented on application specific integrated circuits (“ASICs”), very large scale integrated (“VLSI”) circuits, or other circuitry. In fact, persons of ordinary skill in the art may utilize any number of suitable structures capable of executing logical operations according to the described embodiments.

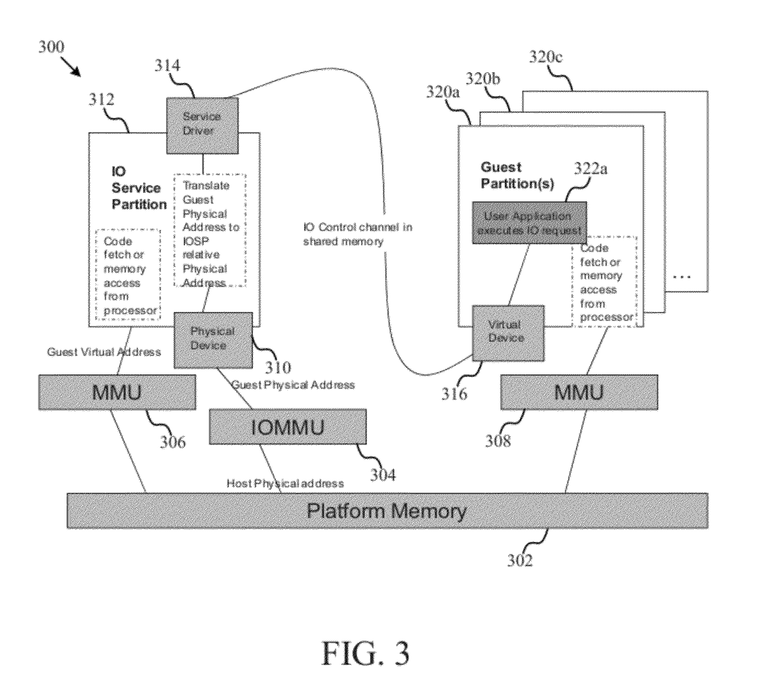

FIG. 3 is a block diagram illustrating a virtual system environment according to one embodiment of the disclosure. A system 300 includes a number of guest partitions 320a, 320b, 320c. A guest partition 320a may execute a user application 322a, which creates an I/O request to a guest physical address. The I/O request is passed to a virtual device 316 corresponding to the guest physical address, which may be coupled through an I/O control channel to a service driver 314. The I/O control channel may be in shared memory (not shown). The service driver 314 is part of the IOSP 312, which translates I/O requests from the guest physical address to an IOSP relative physical address. According to one embodiment, the IOSP 312 is a partition environment running in a separate virtual memory space on the system 300. The translated I/O request accesses the physical device 310, which passes a guest physical address to an I/O memory management unit (“IOMMU”) 304. The IOMMU 304 may translate the guest physical address to a host physical address to access a platform memory 302.

When an I/O request is passed from the guest 320a to the IOSP 312, the IOSP 312 is responsible for performing the I/O request. For example, the IOSP 312 may access a disk or network device. The IOMMU 304, which may be operating on a support chipset with support for VT-d, may translate guest physical addresses into host physical addresses for accessing the physical memory. The IOSP 312 may support multiple guests 320a, 320b, 320c simultaneously. According to one embodiment, the IOSP 312 is implemented in a Linux kernel. In some embodiments, IOSP 312's address space may be extended to include no-access memory sections. According to another embodiment, the IOSP 312 may be implemented to support hardware without VT-d by translating guest physical addresses into host physical addresses for hardware DMA access.

According to some embodiments, the firmware in the platform is implemented to provide guest memory to IOSPs as a no-access segment to the IOSP, as such an implementation may improve shared storage performance. In such embodiments, the firmware may be modified to comprise one or more key changes. The first such change may include updates to allow the ComputePages algorithm in the control module that manages the memory segment allocation to only update the MMUIO if the segment type has the IORAM attribute. When ClientRam segments are added to the IOSP partition, entries may be added to the IOSP's MMUIO via SendCreateAlias. A new SendDetachAlias method may be added that may be called when removing ClientRam segments from an IOSP. According to one embodiment, the state of the segments (units of memory management assigned to a partition) for the partition may be maintained. Support for the ClientRam segment type may also be added. The second such change may comprise updates to resize MMU channels. The third such change may comprise updates to add/remove client RAM segments.

By way of example, without limitation, when adapting the firmware, the first implementation change may include adding IORAM segment attributes to the ClientRam segment in segment management methods. The first implementation change may also include replacing an address attribute with IORAM in the segment attribute structure. The first change may further include replacing the address attribute with IORAM and adding IOMMU and other segment roles to an enumerated segment role type. The first change may also include setting a flag for Guest Physical Address allocated from the Service Partition module and calling the new SendCreateAlias method to maintain the state of the segment. The first change may further include adding a SendDetachAlias method to the Channel Context module when the partition no longer accesses the segment or partition. The first change may also include adding the ClientRam unique guide to aid in identifying the segments allocated to ClientRam segments. The first change may further include a method improvement for parsing IORAM segment attributes from an XML configuration file. The first change may also include modifications to the Resource Allocation database module (“ControlDb”) such as setting VTD_READ and VTD_WRITE I/O permissions if a segment has the IORAM attribute.

Building further upon the example provided above, the second of three changes may include updates to the firmware to resize MMU channels. The second change may resize the MMUIO, MMUMAP, MMUROOT, MMUEPT (Extended Page Table), and MMUSHADOW tables in a shared IOSP. The amount of discovered memory may be stored in the ControlDb's MaxMemoryMb variable. The MMUMAP, MMUROOT, MMUEPT, and MMUSHADOW tables are expanded to accommodate the additional memory used by MMUIO table.

For example, when adapting the platform firmware, the second change may include modifications to a low level platform firmware file such as, without limitation: increasing the amount of 4K pages allocated to the MMUIO to accommodate discovered memory, and increasing the amount of 4K pages allocated to the MMUMAP and MMUROOT to accommodate all of the MMUIO memory. The second change may also include increasing the value of the ControlDb's MaxMemoryMb by 4 for every 4 MB discovered. The second change may further include modifying the ControlDb Initialization function by increasing the ControlDb's MaxMemoryMb by (PoolSize*4), where PoolSize is in increments of 4 MB. The second change may also include reducing the shadow and ept default number of pages in the MMU_MAP_CHANNEL shared memory structure. The second change may also include modifying memory segment configuration files by removing IODEV from the ClientRam segment type, and by adding ATTACH to the CommandUsage command for the GenericDevice segment type. While spe

The third of three changes may include updates to the platform firmware to update commands for adding and/or removing client RAM segments. The third change adds a ClientRam segment to the IOSP partition for every VirtualRam segment created for the IOSP's clients. Thus, the IOSP's MMUIO may contain the addresses for all of the memory used by the IOSP's clients. The segments may be added in an AssignChannels method that selects the channel memory, requests the control partition to create the channel, and links it to the associated server channel. Requests to create and/or remove client ram segments may be placed on the IOSP's worker thread queue.

For example, when adapting the platform firmware, the third change may include modification to the Partition Context handling code to call a RequestCreateClientRamSegments method to place a request on IOSP's worker thread queue during AssignChannels, to call a RequestRemoveClientRamSegments method to place a request on IOSP's worker thread queue during anUnAssignMemory method, and to add create client ram and remove client ram support to a main handler. The third change may also include modifications to Service Partition handling code to add a RequestCreateClientRamSegments method to place a create client ram segment request on the IOSP's worker thread queue, to add a RequestRemoveClientRamSegments method to place a remove client ram segment request on the IOSP's worker thread queue, to add an AddClientRamSegments method to remove client ram alias segments from the IOSP, and to add a GetFirstPages method to return a hashtable containing the FirstPages of all of the channels in the IOSP partition with a particular segment type index. The GetFirstPages method may provide a safety net to ensure ClientRam segments with duplicate addresses are not added. The third change may further include modifications to the I/O specific Service Partitions module to add a RequestCreateClientRamSegments method to place a create client ram segment request on the IOSP's worker thread queue, and to add a RequestRemoveClientRamSegments method to place a remove client ram segment request on the IOSP's worker thread queue. The third change may also include adding work items to a Partition Work Items module to create client ram requests and remove client ram requests.

In some embodiments, functionality may be emulated to allow the end user point of view to remain unchanged. With an IOSP not running on top of an IOMMU architecture, addresses may be translated differently within the IOSP. Addresses may be translated with the assistance of additional data, or meta data, describing the address. The meta data may be attached in unused bits of an address of an I/O request. For example, if an operating system only supports 40 bits, but 64 bit addresses are available, the additional 24 bits may be used to carry meta data about the address or I/O request. According to one embodiment, the meta data may be data for identifying a guest making the I/O request.

For systems without VT-d support there is no IOMMU available to translate guest physical addresses, thus code may be used to translate the guest physical addresses directly into host physical addresses by traversing the MMU table. Then, the address may be passed through to a Linux kernel. One bit of the address, such as bit 40, may be used as an identifier for other code to know the address has been adjusted.

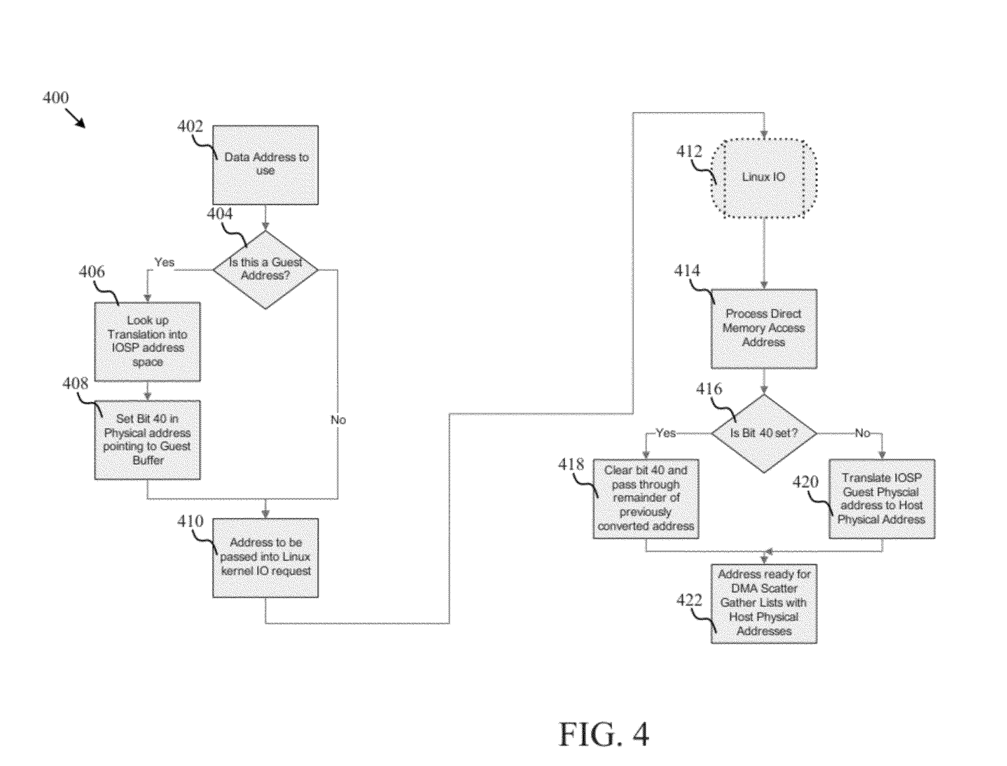

FIG. 4 is a flow chart illustrating the use of a memory address to convey information in a non VT-d system according to one embodiment. A method 400 begins at block 402 with receiving a data address for use. At block 404 the address is determined to be a guest address. If the address is not a guest address the method 400 continues to block 410. If the address is a guest address the method 400 continues to block 406 to look up a translation for the guest address into the IOSP address space. At block 408 bit 40 is set (or another appropriate bit) in the physical address pointing to a guest buffer. At block 410 the address is an address to be passed into a Linux kernel I/O request.

At block 412 of the method 400 the I/O request is processed by the Linux kernel, which may call direct memory access (“DMA”) routines. At block 414 the DMA address is processed. While processing the DMA address, addresses used to access guest data buffers and addresses used to access IOSP memory buffers are differentiated. At block 416 it is determined if bit 40 (or another appropriate bit) was set at block 408. If the bit is set the method 400 continues to block 418 to clear the bit and pass through the remainder of the previously converted address. If the bit is not set the method 400 continues to block 420 to translate the IOSP guest physical address to a host physical address. At block 422 the address is ready for DMA scatter gather lists with host physical addresses.

In some embodiments, an operating system may be adapted for modifying an I/O storage driver to use 4K page translations at the top of a driver stack. The adaptation may be implemented in a number of patches to open source code and changes to proprietary implementations. A first patch may revise the operating system, such as a Linux kernel, to support DMA to a guest's memory space. When DMA is performed into the guest's memory, the IOSP may be unable to buffer bounce any I/O requests. The first patch may modify mm/bounce.c to place a BUG_ON if the IOSP were to attempt a buffer bounce. Additionally, the pci-nommu_{—}64.c file may be updated to export 4 KPageTranslate function for guests are not the IOSP. For non-VT-d systems, a 2 TB offset may be used to signify a guest address has already been translated. For systems having VT-d, guest memory is hardware physical identity mapped to the IOSP's MMUIO tables. The first patch may also allow GuestToGuestCopy mechanism to be used with memory accesses outside of the ClientRam segments.

A second patch may adapt previous modifications to an operating system to remove the GuestToGuest copy calls from the data path for disk access and from the transmit path of network. During processing of incoming SCSI commands, a list of guest physical pages may be converted to IOSP relative pfns and a scattergather list may be created with the IOSP related addresses. The scattergather list may be passed to scsi_execute_async.

A third change may adapt the firmware to remove items cleanly from IOMMU during BUS_DESTROY. The change may add a Control Virtual Machine Message (“ControlVmm”) call to invalidate the VTD cache. The change may also create and/or destroy ClientRam segments and send the new invalidate VTD cache message when the ClientRam segments are created/destroyed.

For example, when adapting the platform firmware, the controlvmmchannel.h file may be modified: by adding a CONTROLVMM_INVALIDATE_VTD_CACHE Id, and by adding a ControlVmm invalidateVtdCache message struct. The ControlVmm structures may be updated: by adding a CONTROLVMM_INVALIDATE_VTD_CACHE and missing IDs, and by adding ControlVmmCmdVmmInvalidateVtdCache message struct. The Partition Context code may be updated: to modify DoVmmWork to receive CONTROLVMM_INVALIDATE_VTD_CACHE events, to add VtdCacheInvalidated method to handle received CONTROLVMM_INVALIDATE_VTD_CACHE events, and to modify UnAssignMemory to send new CONTROLVMM_INVALIDATE_VTD_CACHE requests. The Resource Root and IResource Root code may be modified to add SendInvalidateVtdCacheToBoot method to find boot partitions and send a CONTROLVMM_INVALIDATE_VTD_CACHE requests through the boot partition. The Resource Root and IResource Root code may also be modified to have an updated ProcessControlVmmEvent to receive CONTROLVMM_INVALIDATE_VTD_CACHE events. The System Partition and ISystem Partition code may be updated to add a SendInvalidateVtdCache method for sending a CONTROLVMM_INVALIDATE_VTD_CACHE request. The Partition Work Items code file may be modified to add a WiVmmInvalidateVtdCache class. The Control Db Vmm code may be modified: to include the interface to the Control Db Pages APIs for CBVirtToRootVirt calls, to include CellDataChannel for cell struct references, to update ControlDbPrepareControlVmmMessage to include CONTROLVMM_INVALIDATE_VTD_CACHE as a valid identifier, and to update ControlDbApplyControlVmmMessage to insert a CONTROLVMM_INVALIDATE_VTD_CACHE request for each DMA Remapping Unit Descriptor. The Control Virtual Machine Message code may be updated to include a new ControlVmm CONTROLVMM_INVALIDATE_VTD_CACHE message. The Virtual Machine Call code may be updated to include a new ControlVmm message to make VmCall requests unnecessary.

A fourth change may include changes to remove invalidating VT-d cache VMCALLS. The fourth change may remove all references to no longer used VMCALL_CONTROL_INVALIDATE_VTD_CACHE. A fifth change may include changes to further remove invalidated VT-d cache VMCALLs. The fifth change may remove references to the no longer used VMCALL_CONTROL_INVALIDATE_VTD_CACHE.

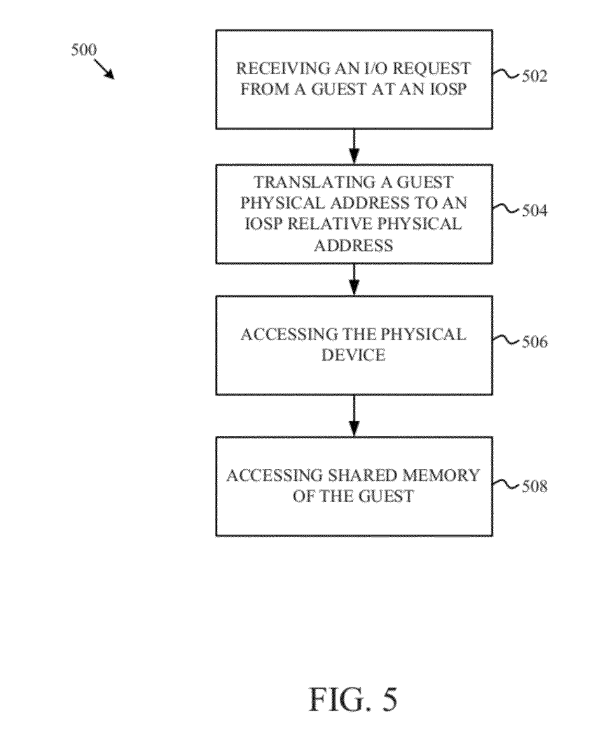

FIG. 5 is a flow chart illustrating a method according to some embodiments of the disclosure. A method 500 begins at block 502 with receiving, at an IOSP, an I/O request from a guest. At block 504 a guest physical address of the I/O request is translated to an IOSP relative physical address. At block 506 the physical device corresponding to the IOSP relative physical address is accessed. At block 508 shared memory of the guest may be accessed by the physical device.

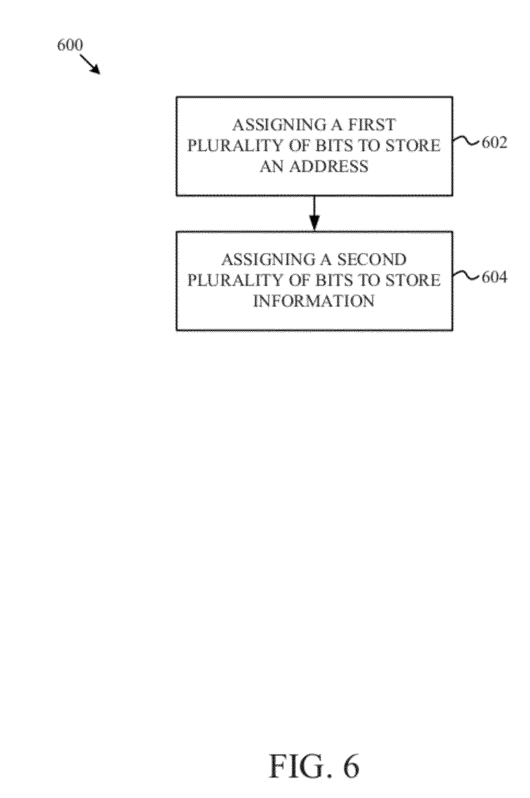

FIG. 6 is a flow chart illustrating a method according to another embodiment of the disclosure. A method 600 begins at block 602 with assigning a first plurality of bits to store an address. At block 604 a second plurality of bits are assigned to store meta data information.

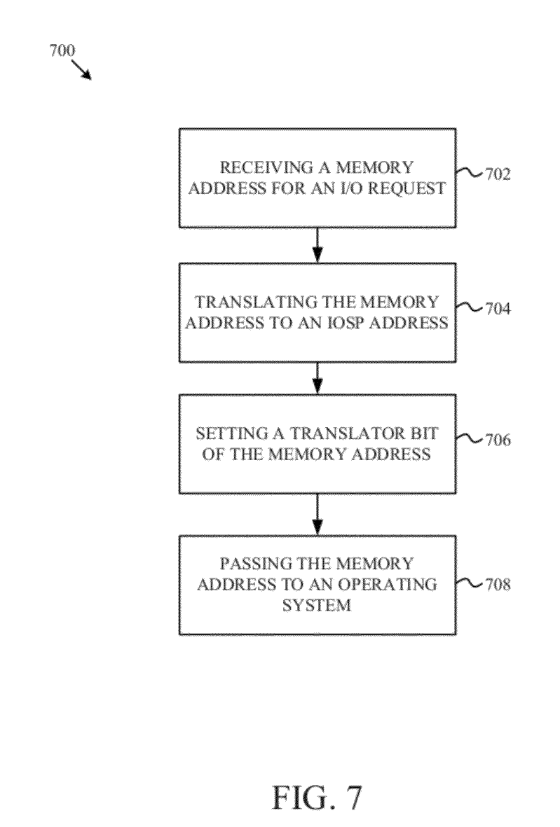

FIG. 7 is a flow chart illustrating a method according to yet another embodiment of the disclosure. A method 700 begins at block 702 with receiving a memory address for an I/O request. At block 704 the memory address is translated to an IOSP address. At block 706 a translator bit of the memory address is set indicating the memory address has been translated. At block 708 the memory address is passed to an operating system.

As disclosed above, a soft partitioning system may allow multiple virtual system environments to execute on a single platform may include IOSPs. The IOSPs operating in a separate virtual memory space on the platform and service disk and network requests from multiple guests. Thus, providing a secure and efficient system. The IOSPs provide translation from virtual addresses to physical addresses such that from the point of view of the guest the virtual addresses used by the guest appear to be physical addresses. The IOSP may be implemented in a Linux kernel. The address space of the IOSP may be extended to include DMA memory sections such that the Linux kernel does not include all of the guest's memory. The IOSP may be operating on hardware that does or does not support virtualization technology for directed I/O.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. An apparatus, comprising:
a guest partition;
an input/output service partition (IOSP) coupled to the guest partition through a control channel;
a memory management unit (MMU) coupled to the IOSP; and
a platform memory coupled to the MMU.

2. The apparatus of claim 1, in which the control channel coupling the IOSP to the guest partition is in shared memory.

3. The apparatus of claim 1, further comprising an input/output memory management unit (IOMMU) coupled to the IOSP and the platform memory.

4. The apparatus of claim 1, in which the IOSP comprises:
a service driver; and
a physical device.

5. The apparatus of claim 4, in which the IOSP translates a guest physical address to an IOSP relative physical address.

6. The apparatus of claim 1, further comprising a memory management unit coupled to the guest partition and coupled to the platform memory.

7. A method, comprising:
receiving, at an I/O service partition (IOSP), an input/output (I/O) request from a guest;
translating a guest physical address of the I/O request to an IOSP relative physical address;
accessing the physical device corresponding to the IOSP relative physical address; and
accessing, by the physical device, shared memory of the guest.

8. The method of claim 7, in which accessing the shared memory comprises accessing a platform memory through an I/O memory management unit (IOMMU).

9. The method of claim 8, in which the IOMMU translates a guest physical address to a host physical address of the platform memory.

10. The method of claim 8, further comprising receiving a message from the platform memory indicating accessing the shared memory is complete.

11. The method of claim 7, in which the I/O request is received at a service driver of the IOSP.

12. The method of claim 7, further comprising generating a map of the shared memory of the guest for accessing by the physical device.

13. A computer program product, comprising:
a computer-readable medium comprising:
code to receive an input/output (I/O) request from a guest;
code to translate a guest physical address of the I/O request to an IOSP relative physical address;
code to access the physical device corresponding to the IOSP relative physical address; and
code to access shared memory of the guest.

14. The computer program product of claim 13, in which the medium further comprises code to access a platform memory through an I/O memory management unit (IOMMU).

15. The computer program product of claim 14, in which the medium further comprises code to translate a guest physical address to a host physical address of the platform memory.

16. The computer program product of claim 14, in which the medium further comprises code to receive a message from the platform memory indicating accessing the shared memory is complete.

17. The computer program product of claim 13, in which the medium further comprises code to receive the I/O request from a service driver of the IOSP.
